(19) United States
(12) Patent Application Publication
(10) Pub. No.: US 2015/0186029 A1
(43) Pub. Date: Jul. 2, 2015

(54) MULTISCREEN TOUCH GESTURE TO DETERMINE RELATIVE PLACEMENT OF TOUCH SCREENS

(71) Applicant: Samsung Electronics Co., Ltd., Suwon-si (KR)

(72) Inventor: Aamer KHANI, San Jose, CA (US)

(73) Assignee: Samsung Electronics Co., Ltd., Suwon-si (KR)

(21) Appl. No.: 14/143,625

(22) Filed: Dec. 30, 2013

(51) Int. Cl. G06F 3/0488

(52) U.S. Cl. CPC G06F 3/04883

(57) ABSTRACT

A method of determining a relative orientation of a plurality of devices is provided. The method includes detecting a continuous touch gesture on one or more of the plurality of devices, determining, based on at least one characteristic of the continuous touch gesture, the relative orientation of one or more of the plurality of devices, and displaying, based on the determined relative orientation, an image on a display of at least one of the plurality of devices.

### TECHNICAL FIELD

The present disclosure relates to a method of configuring displays. More particularly, the present disclosure relates to using a continuous touch gesture to determine the relative positions of a plurality of touch screen displays.

### BACKGROUND

Electronic devices have been developed to include a wide variety of display unit sizes and types. Some electronic devices have been developed to incorporate multiple display units for user convenience, and some to enable a device to display two separate images corresponding to two separate programs simultaneously. Likewise, computing applications have been developed which allow a user, via a configuration User-Interface (UI), to configure multiple displays relative to one another.

FIG. 1 is a screen image of a UI for configuring multiple displays according to the related art.

Referring to FIG. 1, a UI 100 is shown which depicts the “Multiple Monitor Support In Windows” feature of Microsoft Windows®. This UI 100 allows a user to orient each of two displays in either a landscape or portrait orientation (i.e., a rotation of 90 degrees), and allows a user to determine an order of displays from left to right or from right to left. In the figure, a first display 110 is indicated with a number 1 and is designated as being located to the right of a second display 120 indicated with a number 2. This approach to configuring multiple displays is limited in its ability to handle more complex configurations, and can require significant set up time.

FIG. 2 is a screen image of another UI for configuring multiple displays according to the related art.

Referring to FIG. 2, a UI 200 of the freely available “Synergy” cross-platform application is shown. Synergy exists under the terms of the GNU General Public License. Synergy allows a user to designate, via the UI 200, the relative positions of multiple displays on a grid 210. In the figure, a main display 220, a recording display, 230 and a laptop display 240, are each shown on the grid 210. A user may drag and drop displays 220, 230 and 240 into any arrangement in the grid 210.

The foregoing methods are limited in the manner in which a user can specify the orientation of displays relative to one another. That is, these methods are limited to designating displays to be aligned with one another in one plane, to allow a display to be positioned directly above, below, or to the side of another display, and which may only be rotated by 90 degrees. Each of these methods is thus limited in the ability to display desired configurations. Also, because each is a manual process, each also requires considerable setup time. In this regard, there is an increasing demand for systems, methods and devices which are capable of more dynamic multiple display configurations, and which decrease the time and effort required for setting up the display configuration.

To improve the user experience, many electronic devices have also been developed to include a touch screen having a touch panel and a display panel that are integrally formed with each other and used as the display unit thereof. Such touch screens have been designed to deliver display information to the user, as well as receive input from user interface commands. Likewise, many electronic devices have been designed to detect gestures in order to simplify and to enhance user interaction with the device.

For example, a system has been developed that uses a multi-tap gesture to configure screens. In this system, a hold input is recognized when the input is held to select a displayed object on a first screen of a multi-screen system, and a tap input is recognized when the displayed object continues being selected at a second screen of the multi-screen system. Nonetheless, this system fails to provide any method for determining the relative orientation of devices.

Another system has been developed that uses a dual tap gesture to configure screens. In this system, a first tap is input and recognized with respect to a displayed object of a first screen of a multi-screen system, and a second tap, recognized approximately when the first tap input is recognized, is input at a second screen of the multi-screen system. These two taps comprise a dual tap gesture. However, this system also fails to provide any method for determining the relative orientation of devices.

Another system has been developed that uses a pinch-to-pocket gesture. In this system, a first motion is input and recognized to select a displayed object at a first screen region of a first screen of a multiscreen system. A second motion is input and recognized to select a displayed object at a second screen region of a second screen of the multi-screen system. A pinch to-pocket gesture for “pocketing” the displayed object can then be determined from the recognized first and second motion inputs within the respective first and second screen regions. Nonetheless, this system also fails to provide any method for determining the relative orientation of devices.

Thus, despite certain advances, electronic devices, systems and methods have not been developed to adequately address the need for a simpler and less time consuming method of configuring multiple displays, which allows for more complex display arrangements.

Therefore, a need exists for a system, method and device which allow a user to apply a continuous touch gesture to a plurality of devices in order to more easily and effectively determine and configure relative positions of the plurality of devices.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a system, apparatus and method for using a continuous touch gesture to determine and configure relative positions of a plurality of touch screen displays.

In accordance with an aspect of the present disclosure, a method of determining a relative orientation of a plurality of devices is provided. The method includes detecting a continuous touch gesture on at least one of the plurality of devices, determining, based on at least one characteristic of the continuous touch gesture, the relative orientation of at least one of the plurality of devices, and displaying, based on the determined relative orientation, an image on a display of at least one of the plurality of devices.

In accordance with another aspect of the present disclosure, a system of determining a relative orientation of a plurality of devices is provided. The system includes the plurality of devices, a sensor configured to detect a continuous touch gesture on at least one of the plurality of devices, a controller configured to determine, based on at least one characteristic of the continuous touch gesture, the relative orientation of one or more of the plurality of devices, and a display on at least one of the plurality of devices configured to display an image based on the determined relative orientation.

In accordance with another aspect of the present disclosure, an electronic device is provided. The electronic device includes a sensor configured to detect a continuous touch gesture, a controller configured to determine, based on at least one characteristic of the continuous touch gesture, the relative orientation of the electronic device with respect to one or more other electronic devices, and a display configured to display an image based on the determined relative orientation of the electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a screen image of a User Interface (UI) for configuring multiple displays according to the related art;

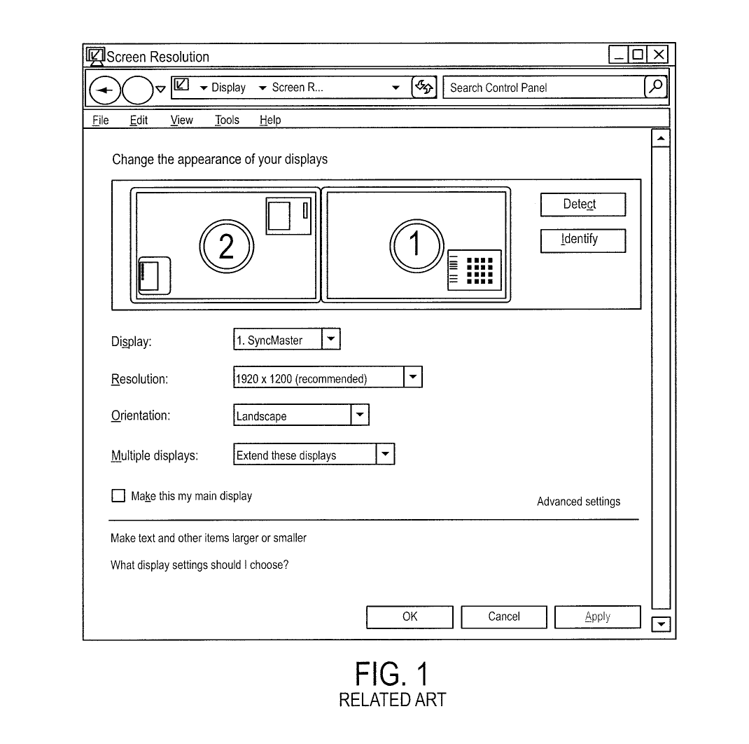

FIG. 2 is a screen image of another UI for configuring multiple displays according to the related art;

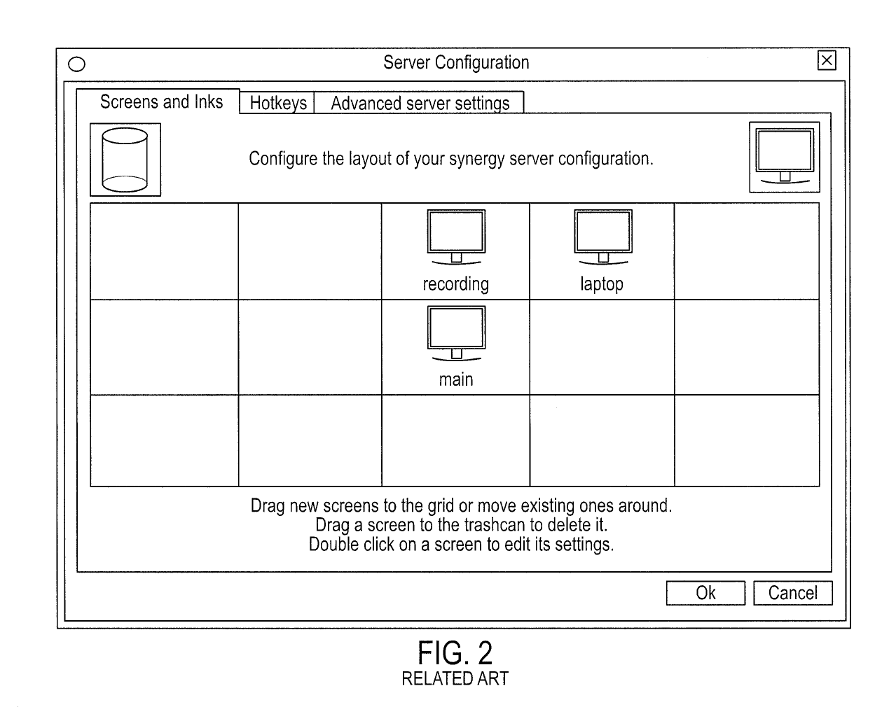

FIG. 3 illustrates a multiple display configuration according to an embodiment of the present disclosure;

FIG. 4 illustrates a multiple display configuration according to an embodiment of the present disclosure;

FIG. 5 illustrates an exploded view of a section of the multiple display configuration of FIG. 4 according to an embodiment of the present disclosure;

FIG. 6 illustrates an exploded view of a section of a multiple display configuration according to an embodiment of the present disclosure;

FIG. 7 illustrates an erroneous interpolation result according to an embodiment of the present disclosure;

FIG. 8 illustrates an exploded view of a section of a multiple display configuration according to an embodiment of the present disclosure;

FIG. 9 illustrates a complete touch gesture according to an embodiment of the present disclosure;

FIG. 10 illustrates an image displayed across the multiple display configuration illustrated in FIG. 9 according to an embodiment of the present disclosure;

FIG. 11 illustrates an image displayed across the multiple displays shown in FIGS. 6 and 7 reconfigured according to an embodiment of the present disclosure;

FIG. 12 is a block diagram of a touch screen device according to an embodiment of the present disclosure; and

FIG. 13 is a block diagram of software modules in a storage unit of the touch screen device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

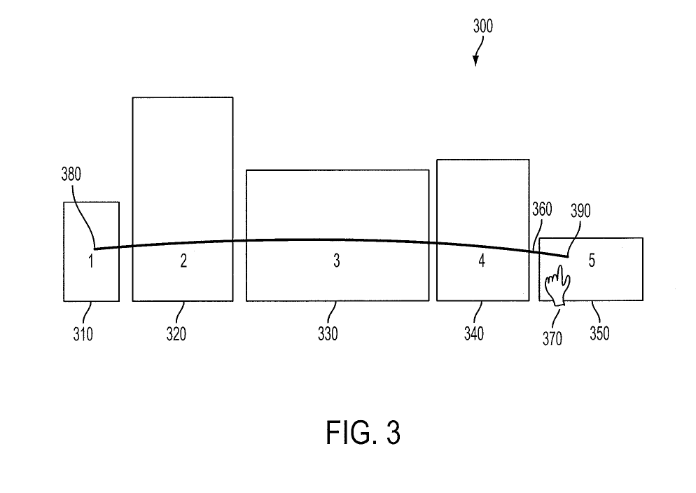

FIGS. 3-13, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

Terms such as “touch screen,” “electronic device,” “mobile device,” “handheld device,” “tablet,” “desktop,” “personal computer,” or the like, do not in any way preclude other embodiments from being considered equally applicable. Unless otherwise noted herein, a touch screen, an electronic device, a mobile device, a handheld device, a tablet, a desktop, a personal computer, or the like, or any other device or component of a device with a touch screen display, touch sensitivity, or the like, may in various implementations be considered interchangeable.

Reference to the terms and concepts of a monitor, a display, a screen and a touch screen herein should not be considered to limit the embodiments of the present disclosure in any way. In various embodiments, such terms and concepts may be used interchangeably.

In embodiments, the methods, systems and devices described herein may be implemented, in whole or in part, in a single device, in multiple devices, in a system, or in any other suitable manner.

FIG. 3 illustrates a multiple display configuration according to an embodiment of the present disclosure.

Referring to FIG. 3, a straight line configuration of several displays 300 is shown, each display thereof corresponding to an electronic device including the display in the form of a touch screen display. The displays are arranged in order from left to right; display 1 310 is located in a first position, display 2 320 is located in a second position, display 3 330 is located in a third position, display 4 340 is located in a fourth position and display 5 350 is located in a fifth position. A continuous touch gesture 360 across the respective displays is made by a finger 370. The touch gesture has a start point 380 and an end point 390. In this manner, each respective device has been chosen by a user and arranged in a desired orientation (i.e., a line from left to right) so that a user may then set hardware or software to cause to display images or parts of an image on the respective displays according to the order specified. To communicate the desired orientation of the devices, the user may make a touch gesture on one or more of the plurality of devices. That is, for example, a determination may be made, based on at least one characteristic of a continuous touch gesture, of the relative orientation of the devices, and, based on the determined relative orientation of the devices, a desired image may be displayed on a display of at least one of the plurality of devices.

In an embodiment, the touch gesture may be made by a user's body part, such as a finger or a hand, or may be made by other devices or objects, such as a stylus, or by any other suitable implement capable of interacting with a touch screen device. The touch gesture may be a swipe gesture, a drag gesture, or any other gesture capable of actuating a touch sensitive device.

In an embodiment, a touch gesture may occur on a touch screen display of a device or may occur on any other touch sensitive device component or on a surface of a device. A touch gesture may occur on one device, or may proceed from one device to another. The type of device is not limited herein, and may be any suitable electronic display, device, mobile device, handheld device, tablet, desktop, personal computer, or the like, or any other device with a touch screen display, or the like.

In an embodiment, a touch gesture may have a fluid motion, such as a motion corresponding to a natural or a predictable gesture. A gesture may exhibit a natural or predictable trajectory, or may exhibit one or more predictable characteristics, such as a velocity at a given point on a touch screen or other component or surface.

In an embodiment, the distance and an orientation of displays may vary. For example, a distance from one display to another display may be non-existent, may be a small distance (e.g., less than 1 mm), or may be any larger distance (e.g., more than 2 meters). Likewise, one display may have a rotational orientation (e.g., of 90° or a landscape orientation) relative to another display, or one display may have a rotational orientation (e.g., 30°) and an axial orientation (e.g., 54°) relative to another display. As is described below, in embodiments these distances and orientations can be known and, if necessary, compensated or accounted for, by the methods described herein.

In an embodiment, the touch gesture may be of a constant or varying pressure. For example, a touch gesture may begin with a start point having a pressure that is greater than or less than a pressure at another point of the touch gesture. Likewise, a touch gesture may be intermittent, thereby having at least two points of contact interrupted by at least one point of no contact. A touch gesture may also have a different pressure at many points along a path. That is, the touch gesture may be continuous or may be discontinuous. A continuous touch gesture may entail continuously gesturing on a touch screen or gesturing across multiple touch screens without stopping or removing the gesture implement (e.g., a finger) or interrupting the gesture motion until the gesture is complete. A discontinuous gesture may be intermittent, or may, e.g., have different points having different pressures.

In an embodiment, the touch gesture may be of a constant or varying velocity. For example, a touch gesture may begin having a velocity that is greater than or less than a velocity at another point of the touch gesture. Likewise, a touch gesture may be varied along its path. That is, a tough gesture may have a different velocity, or may have no velocity, at various points along a path. A touch gesture may also have a constant or varying acceleration.

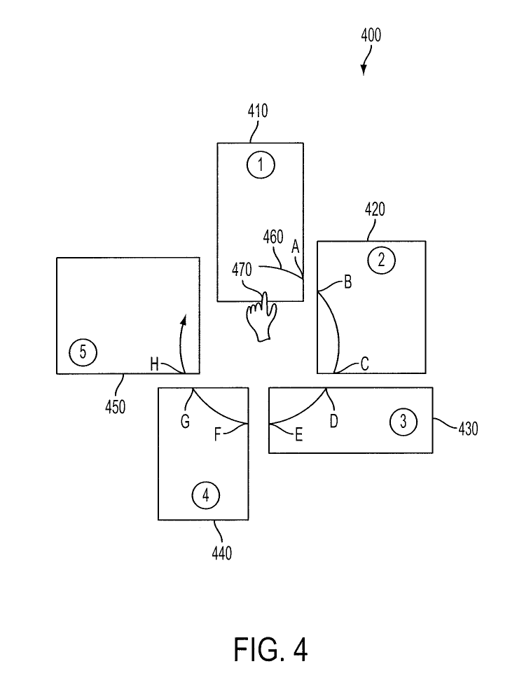

In an embodiment, the touch gesture may enter a particular touch screen display at any location, and may exit a touch screen display at any location. For example, a user wishing to designate a configuration of multiple touch screens may make a continuous touch gesture with a finger across several screens in a circular motion. An embodiment having this configuration will be explained with respect to FIG. 4

FIG. 4 illustrates a multiple display configuration according to an embodiment of the present disclosure.

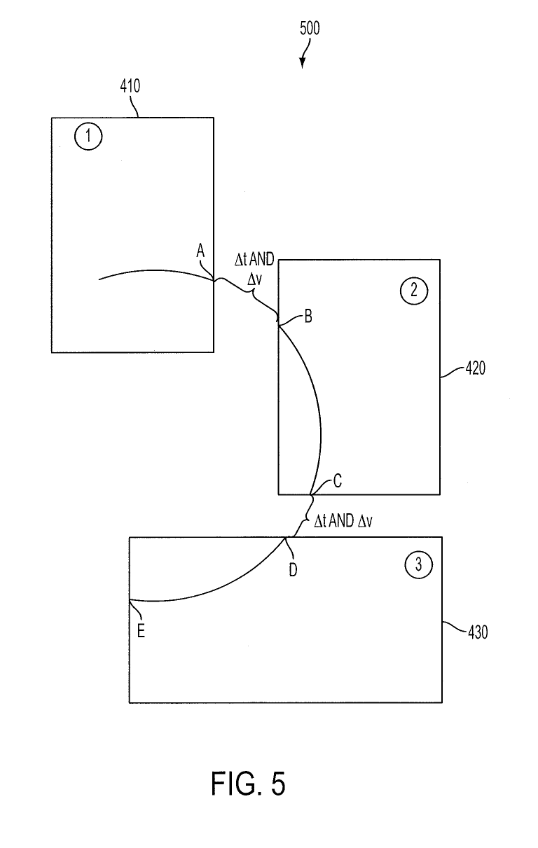

Referring to FIG. 4, a circular configuration of several displays 400 is shown, each display thereof corresponding to an electronic device including the display in the form of a touch screen display. The displays are arranged in a circular pattern and designated to be capable of displaying in a clockwise direction; display 1 410 is located in a first position, display 2 420 is located in a second position, display 3 430 is located in a third position, display 4 440 is located in a fourth position and display 5 450 is located in a fifth position. A continuous touch gesture 460 across the respective displays is made by a finger 470. The touch gesture leaves display 1 410 at point A; enters display 2 420 at point B; leaves display 2 420 at point C; enters display 3 430 at point D; leaves display 3 430 at point E; enters display 4 440 at point F, leaves display 4 440 at point G; and enters display 5 450 at point H. The spaces between consecutive entry and exit points A-B, C-D, E-F, and G-H on displays 1-5 are discussed below in connection with FIG. 5.

The designated orientation of the displays in FIG. 4 may be determined or set by measuring the time and the velocity of each touch gesture at each of points A-H. For instance, at point A, the velocity of the gesture may be 120 mm/s and correspond to a time of 3:24:13.12 (3:24 and 13.12 seconds); at point B, the velocity of the gesture may be 127 mm/s and correspond to a time of 3:24:13.43; at point C, the velocity of the gesture may be 98 mm/s and correspond to a time of 3:24:13.98; and so on. The time and velocity at each of points A-H is then used to interpolate the configuration of the displays relative to one another. That is, the motion of the gesture can be estimated or interpolated by detecting a time and a velocity at each of the respective points of entry and exit of the touch gesture across the respective displays. In this manner, the configuration of the displays can also be determined or be set by detecting a time and a velocity at each of the respective points of exit and entry of the touch gesture across the respective displays. Likewise, the distance and orientation between displays can be interpolated, and if necessary, compensated or accounted for.

FIG. 5 illustrates an exploded view of a section of the multiple display configuration of FIG. 4 according to an embodiment of the present disclosure.

Referring to FIG. 5, the figure represents an exploded view of screens 1-3 depicted in FIG. 4, focusing on the characteristics of the spaces between consecutive gesture entry and exit points A-B and C-D. The spaces between entry and exit points A-B and C-D are each indicated as having a difference in time (Δt) and a difference in velocity (Δv) corresponding to the differences detected between the consecutive points of exit/entry of the detected touch gesture. For example, as noted above, point A corresponds to the exit point of the touch gesture from display 1. At point A, the velocity of the gesture may be 120 mm/s and correspond to a time of 3:24:13.12 (3:24 and 13.12 seconds). Point B corresponds to the entry of the touch gesture on display 2. At point B, the velocity of the gesture may be 127 mm/s and correspond to a time of 3:24:13.43. In this regard, the difference in time (+0.31 seconds) and the difference in velocity (+7 mm/s) between exit point A and entry point B may be used to interpolate the distance and orientation of displays 1 and 2 relative to one another. Further utilizing the known velocity and time of the gesture at points C and D, and so on, each respectively corresponding to a point of exit or entry of the touch gesture on a display, may allow for the interpolation of both the shape of the touch gesture and the configuration of the displays.

In an embodiment (not shown), the above and similar methods of interpolation can be used to interpolate or estimate the characteristics of a gesture or determine a screen configuration that has been set using an intermittent gesture. That is, for example, an intermittent touch gesture may have consecutive points on one or across multiple displays which are separated by a distance and each have a velocity. The touch gesture pattern between these points can thus likewise be estimated or interpolated in the same or in a similar manner as described herein by utilizing the difference between the position, the time and the velocity of the touch gesture measured or detected at each of the relevant points.

In an embodiment, the locations of the points of contact of the touch gesture are not limited herein, and may include points of contact which are adjacent to one another, spaced intermittently from one another, near one another, distant from one another, or the like. The points of contact may be made by a same or similar object, e.g., fingers, or may be made by different objects, e.g., a finger and a stylus. Likewise, the size of the area of the points of contact of a touch gesture across multiple displays, as well as the amount of pressure applied at various points of contact of the touch gesture may be the same or different.

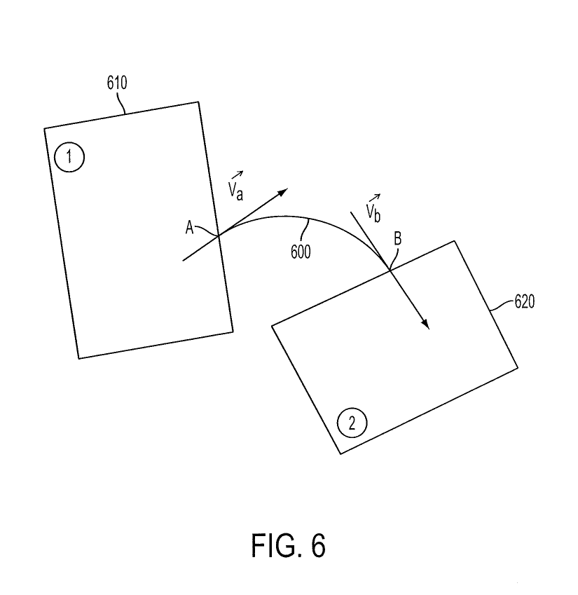

FIG. 6 illustrates an exploded view of a section of a multiple display configuration according to an embodiment of the present disclosure.

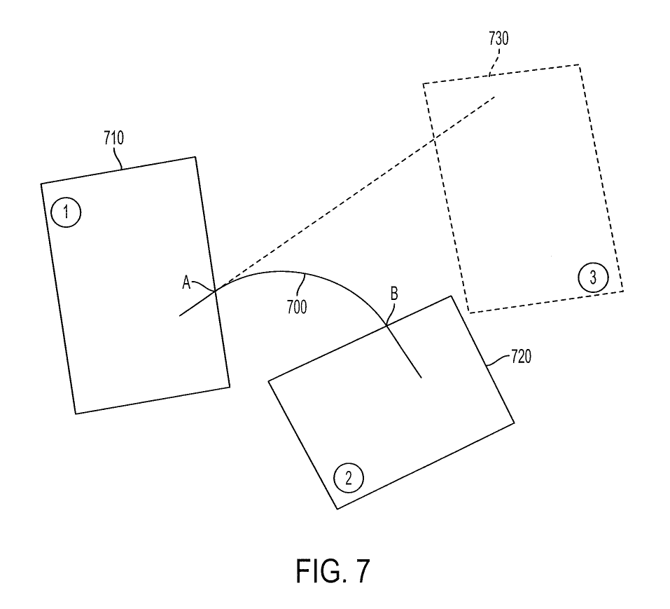

Referring to FIG. 6, a swipe motion 600 is shown as occurring from a display 1 610 to a display 2 620. The swipe leaves display 1 at point A and enters display 2 at point B. The swipe inherently possesses velocity vectors \vec{V}ₐ and \vec{V}_{b} at points A and B, respectively. That is, the velocity vector of the swipe at point A is denoted as \vec{V}ₐ and the velocity vector of the swipe at point B is denoted as \vec{V}_{b}. Based on the orientation of the displays and/or the motion of the swipe, the difference between the trajectory of the exit of the swipe motion from display 1 610 at point A and the trajectory of the entry of the swipe motion into display 2 620 at point B is large. In other words, large angular differences between \vec{V}ₐ and \vec{V}_{b} may exist. In such embodiments, an interpolation method for determining the actual path of the swipe, or for determining the relative positions of display 1 610 and display 2 620 that is based solely on a velocity, a time and a position may render an erroneous interpolation result, as is shown in FIG. 7.

FIG. 7 illustrates an erroneous interpolation result according to an embodiment of the present disclosure.

Referring to FIG. 7, a swipe motion 700 is shown as occurring from a display 1 710 to a display 2 720 as in FIG. 6. The swipe leaves display 1 710 at point A and enters display 2 720 at point B, also as in FIG. 6. An example of an erroneous interpolation result is depicted as the relative position of a hypothetical display 3 730 (i.e., shown as a dotted line). In this scenario, as noted above, since there exist large angular differences in the trajectory of the swipe at points corresponding to \vec{V}ₐ and \vec{V}_{b}, an interpolation method based only on velocity, time and position may erroneously determine the position of displays 1 710 and 2 720. For example, an erroneous interpolation may falsely deduce that displays 1 710 and 2 720 are instead oriented in a manner suggest by the relative positions of display 1 710 and hypothetical display 3 730. To address this and similar or related issues, in embodiments, a compass sensor or similar device (not shown) capable of determining or detecting an absolute angular orientation may be included in a display or a system as discussed below. The inclusion of a compass sensor may allow a determination of an absolute angle of each of the displays, and to thus improve the accuracy of the interpolation.

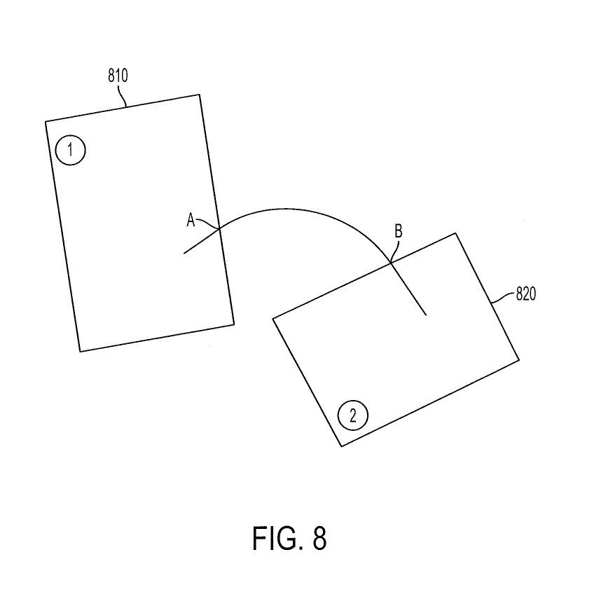

FIG. 8 illustrates an exploded view of a section of a multiple display configuration according to an embodiment of the present disclosure.

Referring to FIG. 8, a swipe motion 800 is shown as occurring from a display 1 810 to a display 2 820. Each of display 1 810 and display 2 820 include a compass sensor (not shown) which enables each display to know its objective angular orientation. By knowing an objective angular orientation of each of display 1 810 and display 2 820, the direction and magnitude (i.e., velocity or speed) of \vec{V}ₐ and \vec{V}_{b}, of the swipe at points A and B can also be known. Thus, in embodiments, the inclusion of one or more compass sensors allows for a more accurate interpolation by allowing a processor to consider a determined time, as well as the characteristics (e.g., magnitude and direction) of swipe motion vectors \vec{V}ₐ and \vec{V}_{b} at points A and B. That is, the known time and velocity of the swipe at point A, as well as the compass angle of display 1 810 (as detected by the compass sensor in display 1 810; not shown), can be used in conjunction with the known time and velocity of the swipe at point B along with the compass angle of display 2 820 (as detected by the compass sensor in display 2 820; not shown) for a more accurate interpolation of the motion of the swipe, or of a corresponding orientation of the displays.

In embodiments, the compass may be included in one or more displays, or may be included elsewhere in a system. The processing of the determination of the orientation of the display or displays relative to one another and the path of the swipe motion may occur in one device, or across multiple devices, or may occur elsewhere in a system.

In embodiments, the compass sensor may utilize any suitable compass technology, such as that of a magnetic compass, a gyro compass, a magnetometer, a solid state compass, or the like. The compass may be capable of determining magnetic north and south or true north and south. In some embodiments a Global Positioning System (GPS) may alternatively be used to determine true or magnetic north and south. By knowing an objective orientation of each display, the relative orientation of each display may be determined using known techniques and computations, as well as those described herein.

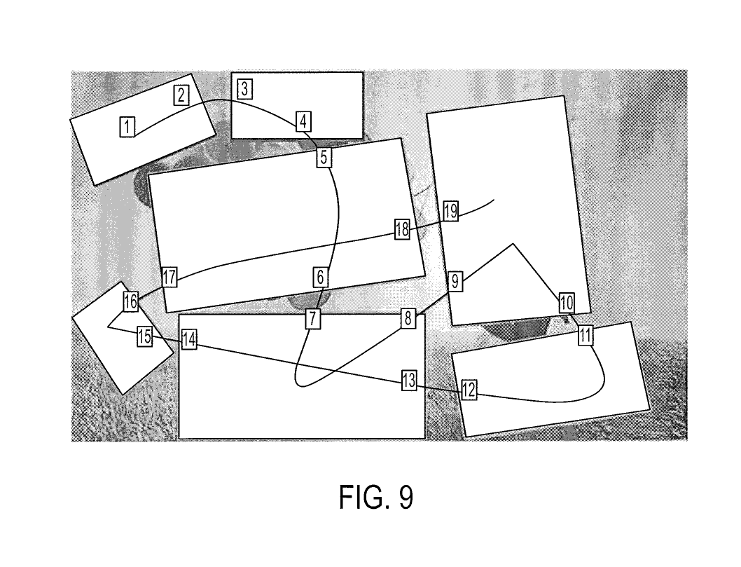

FIG. 9 illustrates a complete touch gesture according to an embodiment of the present disclosure.

Referring to FIG. 9, the figure depicts a complete touch gesture 900 represented across multiple displays, each display representing thereon a part of the detected touch gesture. The touch gesture has an initial start point (i.e., point 1) on a display depicting point 1. The touch gesture then proceeds along the depicted path until it exits the first display at point 2. The touch gesture then enters a subsequent display at point 3. The touch gesture then proceeds along its depicted path and exits the subsequent display at point 4. The touch gesture then enters yet another display at point 5 and exits the display at point 6, and proceeds onward to enter and exit displays in a similar fashion through points 7, 8, 9, 10, 11, 12, 13, 14, 15, 16, 17, 18 and 19. As mentioned above, interpolation techniques can utilize this information to construct the entire original touch gesture. For example, the motion of the gesture can be estimated or interpolated by detecting a time and a velocity at each of the respective points of entry and exit of the touch gesture across the respective displays. In this manner, the configuration of the displays can also be determined or be set by detecting a time and a velocity at each of the respective points of exit and entry of the touch gesture across the respective displays. Likewise, the distance and orientation between displays can be interpolated, and if necessary, compensated for.

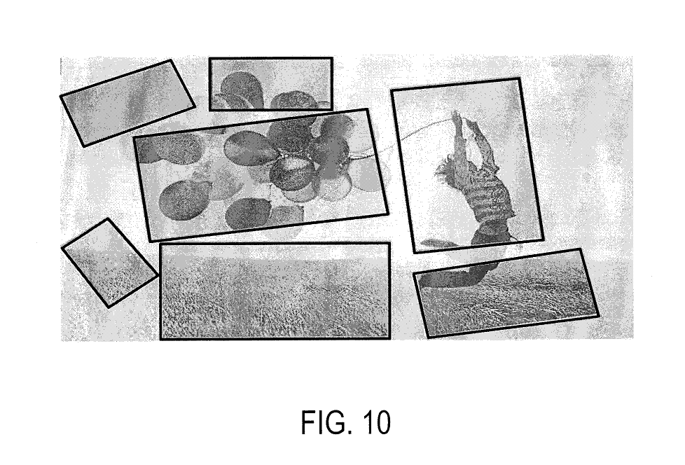

FIG. 10 illustrates an image displayed across the multiple display configuration illustrated in FIG. 9 according to an embodiment of the present disclosure.

Referring to FIG. 10, the figure depicts an image across the multiple displays arranged corresponding to the gesture shown in FIG. 9. In FIG. 10, each display is shown displaying a portion of an image. Together, and accounting for the spaces between the images and the orientation of the images relative one another based on the interpolated touch gesture of FIG. 9, the displays depict the entire image. That is, the spaces between the displays have been compensated for according to the methods described herein, and each display displays its respective portion of the entire image as if the image were overlaid on the screen configuration.

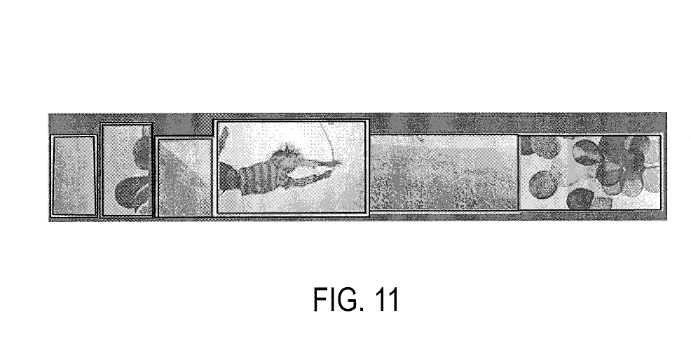

FIG. 11 illustrates an image displayed across the multiple displays shown in FIGS. 9 and 10 reconfigured according to an embodiment of the present disclosure;

Referring to FIG. 11, the displays of FIGS. 9 and 10 are shown reconfigured in a linear fashion. The displays have each been rotationally re-oriented relative to one another. In this embodiment, portions of the image originally shown in FIG. 10, each depicting a portion of a complete image on a separate screen, have been reassembled to form, e.g., a collage, or other arrangement. In this respect, the images displayed on the respective screens can be rearranged much like pieces of a puzzle.

In embodiments, the methods and techniques of the present disclosure can be applied to various video applications. In embodiments, such an application may be a virtual video application wherein several devices (e.g., several mobile devices, each with a touch screen, and each corresponding to a user account or to a user) together display a larger video. Examples of other applications may include video conferencing applications, video gaming applications, and the like. In such applications, by using a touch gesture across multiple touch screens of respective devices, the orientation of the various device displays can be set so as to account for or compensate for the spaces between the devices. In this manner, e.g., each device can be set to display a respective portion of a larger image (according to a configuration suggested by the original touch gesture). The resultant effect may be an effect as if the larger image were overlaid on the multiple display configurations.

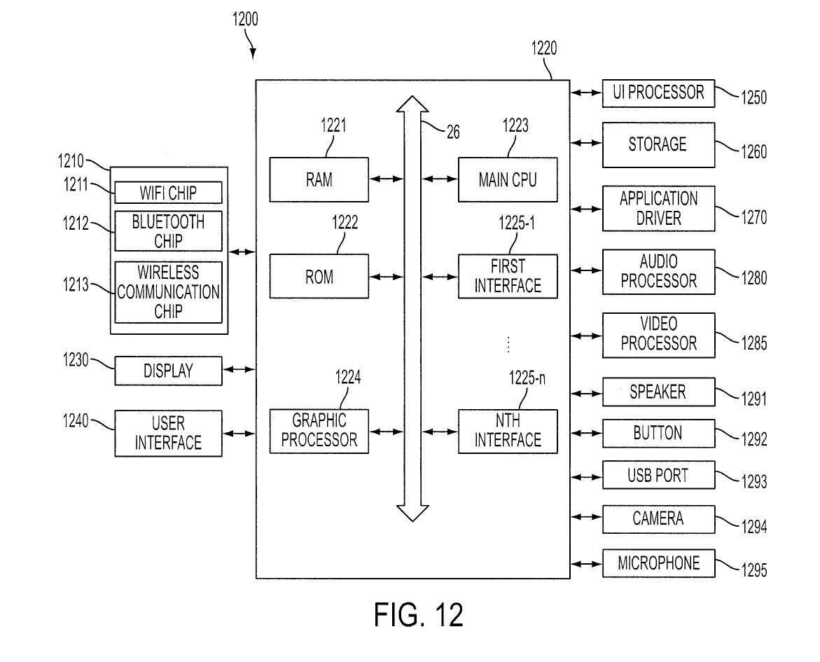

FIG. 12 is a block diagram of a touch screen device according to an embodiment of the present disclosure.

Referring to FIG. 12, the touch screen device 1200 includes a communication device 1210, a controller 1220, a display 1230, a User Interface 1240, a UI processor 1250, a storage unit 1260, an application driver 1270, an audio processor 1280, a video processor 1285, a speaker 12121, a button 12122, a USB port 12123, a camera 12124, and a microphone 12125.

The touch screen device 1210 herein is not limited, and may perform communication functions with various types of external apparatuses. The communication device 1210 may include various communication chips such as a WiFi chip 1211, a Bluetooth® chip 1212, a wireless communication chip 1213, and so forth. The WiFi chip 1211 and the Bluetooth chip 1212 perform communication according to a WiFi standard and a Bluetooth® standard, respectively. The wireless communication chip 1213 performs communication according to various communication standards such as Zigbee®, 3rd Generation (3G), 3rd Generation Partnership Project (3GPP), Long Term Evolution (LTE), and so forth. In addition, the touch screen device 1210 may further include a Near Field Communication (NFC) chip that operates according to an NFC method by using bandwidth from various RF-ID frequency bands such as 135 kHz, 13.56 MHz, 433 MHz, 860-960 MHz, 2.45 GHz, and so on.

In operation, the controller 1220 may read a computer readable medium and perform instructions according to the computer readable medium, which is stored in the storage unit 1260. The storage unit 1260 may also store various data such as Operating System (O/S) software, applications, multimedia content (e.g., video files, music files, etc.), user data (documents, settings, etc.), and so forth.

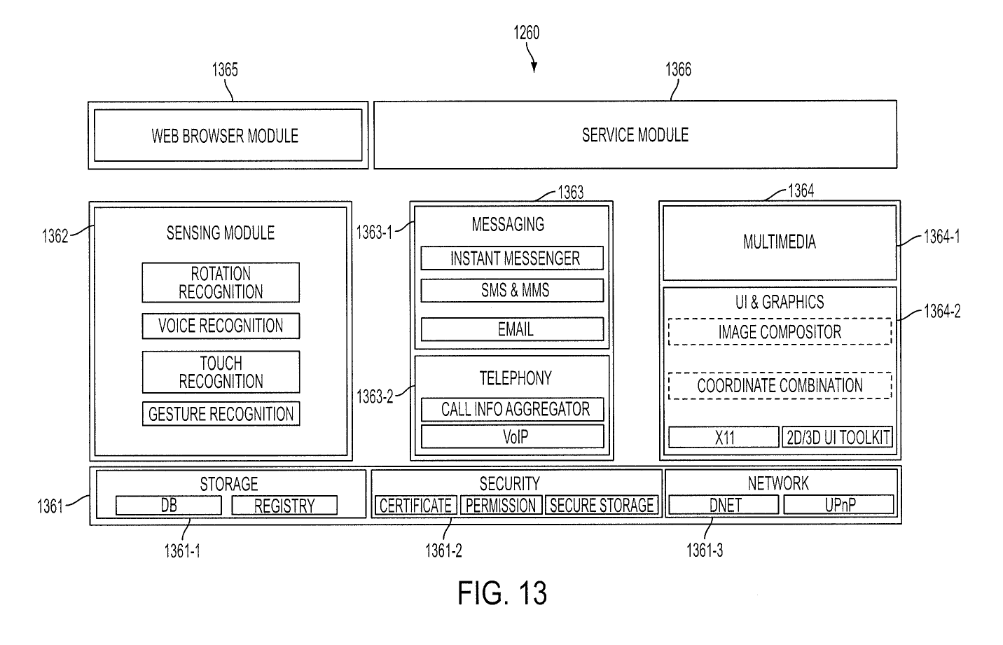

Other software modules which are stored in the storage unit 1260 will be described later with reference to FIG. 13.

The UI 1240 is an input device configured to receive user input and transmit a user command corresponding to the user input to the controller 1220. For example, the UI 1240 may be implemented by any suitable input such as touch pad, a key pad including various function keys, number keys, special keys, text keys, or a touch screen display, for example. Accordingly, the UI 1240 may receive various user commands and touch gestures to manipulate windows on the display of the touch sensitive device. For example, the UI 1240 may receive a user command or an touch gesture to configure a display relative to another display.

The UI processor 1250 may generate various types of Graphical UIs (GUIs).

In addition, the UI processor 1250 may process and generate various UI windows in 2D or 3D form. Herein, the UI window may be a screen which is associated with the execution of the integrated multiple window application as described above. In addition, the UI window may be a window which displays text or diagrams such as a menu screen, a warning sentence, a time, a channel number, etc.

Further, the UI processor 1250 may perform operations such as 2D/3D conversion of UI elements, adjustment of transparency, color, size, shape, and location, highlights, animation effects, and so on.

For example, the UI processor 1250 may process icons displayed on the window in various ways as described above.

The storage unit 1260 is a storage medium that stores various computer readable mediums that are configured to operate the touch screen device 1200, and may be realized as any suitable storage device such as a Hard Disk Drive (HDD), a flash memory module, and so forth. For example, the storage unit 1260 may comprise a Read Only Memory (ROM) for storing programs to perform operations of the controller 1220, a Random Access Memory (RAM) 1221 for temporarily storing data of the controller 1220, and so forth. In addition, the storage unit 1260 may further comprise Electrically Erasable and Programmable ROM (EEPROM) for storing various reference data.

The application driver 1270 executes applications that may be provided by the touch screen device 1200. Such applications are executable and perform user desired functions such as playback of multimedia content, messaging functions, communication functions, display of data retrieved from a network, and so forth.

The audio processor 1280 is configured to process audio data for input and output of the touch screen device 1200. For example, the audio processor 1280 may decode data for playback, filter audio data for playback, encode data for transmission, and so forth.

The video processor 1285 is configured to process video data for input and output of the touch screen device 1200. For example, the video processor 1285 may decode video data for playback, scale video data for presentation, filter noise, convert frame rates and/or resolution, encode video data input, and so forth.

The speaker 12121 is provided to output audio data processed by the audio processor 121280 such as alarm sounds, voice messages, audio content from multimedia, audio content from digital files, and audio provided from applications, and so forth.

The button 12122 may be configured based on the touch screen device 1200 and include any suitable input mechanism such as a mechanical button, a touch pad, a wheel, and so forth. The button 1292 is generally on a particular position of the touch screen device 1200, such as on the front, side, or rear of the external surface of the main body. For example, a button to turn the touch screen device 1200 on and off may be provided on an edge.

The USB port 12123 may perform communication with various external apparatuses through a USB cable or perform recharging. In other examples, suitable ports may be included to connect to external devices such as a 802.11 Ethernet port, a proprietary connector, or any suitable connector associated with a standard to exchange information.

The camera 1294 may be configured to capture (i.e., photograph) an image as a photograph or as a video file (i.e., movie). The camera 1294 may include any suitable number of cameras in any suitable location. For example, the touch screen device 1294 may include a front camera and rear camera.

The microphone 1295 receives a user voice or other sounds and converts the same to audio data. The controller 1220 may use a user voice input through the microphone 1295 during an audio or a video call, or may convert the user voice into audio data and store the same in the storage unit 1260.

When the camera 1294 and the microphone 1295 are provided, the controller 1220 may receive based on a speech input into the microphone 1295 or a user motion recognized by the camera 994. Accordingly, the touch screen device 1200 may operate in a motion control mode or a voice control mode. When the touch screen device 1200 operates in the motion control mode, the controller 1220 captures images of a user by activating the camera 1294, determines if a particular user motion is input, and performs an operation according to the input user motion. When the touch screen device 1200 operates in the voice control mode, the controller 1220 analyzes the audio input through the microphone and performs a control operation according to the analyzed audio.

In addition, various external input ports provided to connect to various external terminals such as a headset, a mouse, a Local Area Network (LAN), etc., may be further included.

Generally, the controller 1220 controls overall operations of the touch screen device 1200 using computer readable mediums that are stored in the storage unit 1260.

For example, the controller 1220 may initiate an application stored in the storage unit 1260, and execute the application by displaying a user interface to interact with the application. In other examples, the controller 1220 may play back media content stored in the storage unit 1260 and may communicate with external apparatuses through the communication device 1210.

More specifically, the controller 1220 may comprise the RAM 1221, a ROM 1222, a main CPU 1223, a graphic processor 1224, first to nth interfaces 1225-1-1225-n, and a bus 1226. In some examples, the components of the controller 1220 may be integral in a single packaged integrated circuit. In other examples, the components may be implemented in discrete devices (e.g., the graphic processor 1224 may be a separate device).

The RAM 1221, the ROM 1222, the main CPU 1223, the graphic processor 1224, and the first to nth interfaces 1225-1-1225-n may be connected to each other through the bus 1226.

The first to nth interfaces 1225-1-1225-n are connected to the above-described various components. One of the interfaces may be a network interface which is connected to an external apparatus via the network.

The main CPU 1223 accesses the storage unit 1260 and initiates a booting process to execute the O/S stored in the storage unit 1260. After booting the O/S, the main CPU 1223 is configured to perform operations according to software modules, contents, and data stored in the storage unit 1260.

The ROM 1222 stores a set of commands for system booting. If a turn-on command is input and power is supplied, the main CPU 1223 copies an O/S stored in the storage unit 1260 onto the RAM 1221 and boots a system to execute the O/S. Once the booting is completed, the main CPU 1223 may copy application programs in the storage unit 1260 onto the RAM 1221 and execute the application programs.

The graphic processor 1224 is configured to generate a window including objects such as, for example an icon, an image, and text using a computing unit (not shown) and a rendering unit (not shown). The computing unit computes property values such as coordinates, shapes, sizes, and colors of each object to be displayed according to the layout of the window using input from the user. The rendering unit generates a window with various layouts including objects based on the property values computed by the computing unit. The window generated by the rendering unit is displayed by the display 1230.

Albeit not illustrated in the drawing, the touch screen device 1200 may further comprise a sensor (not shown) configured to sense various manipulations such as touch, rotation, tilt, pressure, approach, etc. with respect to the touch screen device 1200. In particular, the sensor (not shown) may include a touch sensor that senses a touch that may be realized as a capacitive or resistive sensor. The capacitive sensor calculates touch coordinates by sensing micro-electricity provided when the user touches the surface of the display 1230, which includes a dielectric coated on the surface of the display 1230. The resistive sensor comprises two electrode plates that contact each other when a user touches the screen, thereby allowing electric current to flow to calculate the touch coordinates. As such, a touch sensor may be realized in various forms. In addition, the sensor may further include additional sensors such as an orientation sensor to sense a rotation of the touch screen device 1200 and an acceleration sensor to sense displacement of the touch screen device 1200.

Components of the touch screen device 1200 may be added, omitted, or changed according to the configuration of the touch screen device. For example, a Global Positioning System (GPS) receiver (not shown) to receive a GPS signal from GPS satellite and calculate the current location of the user of the touch screen device 1200, and a Digital Multimedia Broadcasting (DMB) receiver (not shown) to receive and process a DMB signal may be further included. In another example, a camera may not be included because the touch screen device 1200 is configured for a high-security location.

FIG. 13 is a block diagram of software modules in a storage unit of the touch screen device according to an embodiment of the present disclosure.

Referring to FIG. 13, the storage unit 1260 may store software including a base module 1361, a sensing module 1362, a communication module 1363, a presentation module 1364, a web browser module 1365, and a service module 1366.

The base module 1361 refers to a basic module which processes a signal transmitted from hardware included in the touch screen device 1200 and transmits the processed signal to an upper layer module. The base module 1361 includes a storage module 1361-1, a security module 1361-2, and a network module 1361-3. The storage module 1361-1 is a program module including a database or a registry. The main CPU 1223 may access a database in the storage unit 1260 using the storage module 1361-1 to read out various data. The security module 1361-2 is a program module which supports certification, permission, secure storage, etc. with respect to hardware, and the network module 1361-3 is a module which supports network connections, and includes a DeviceNet Module (DNET) module, a Universal Plug and Play (UPnP) module, and so on.

The sensing module 1362 collects information from various sensors, analyzes the collected information, and manages the collected information. The sensing module 1362 may include suitable modules such as a face recognition module, a voice recognition module, a touch recognition module, a motion recognition (i.e., gesture recognition) module, a rotation recognition module, an NFC recognition module, and so forth.

The communication module 1363 performs communication with other devices. The communication module 1363 may include any suitable module according to the configuration of the touch screen device 1200 such as a messaging module 1363-1 (e.g., a messaging application), a Short Message Service (SMS) and a Multimedia Message Service (MMS) module, an e-mail module, etc., and a call module 1363-2 that includes a call information aggregator program module, a Voice over Internet Protocol (VoIP) module, and so forth.

The presentation module 1364 composes an image to display on the display 1230. The presentation module 1364 includes suitable modules such as a multimedia module 1364-1 and a UI rendering module 1364-2. The multimedia module 1364-1 may include suitable modules for generating and reproducing various multimedia contents, windows, and sounds. For example, the multimedia module 1364-1 includes a player module, a camcorder module, a sound processing module, and so forth. The UI rendering module 1364-2 may include an image compositor module for combining images, a coordinates combination module for combining and generating coordinates on the window where an image is to be displayed, an X11 module for receiving various events from hardware, a 2D/3D UI toolkit for providing a tool for composing a UI in 2D or 3D form, and so forth.

The web browser module 1365 accesses a web server to retrieve data and displays the retrieved data in response to a user input. The web browser module 1365 may also be configured to transmit user input to the web server. The web browser module 1365 may include suitable modules such as a web view module for composing a web page according to the markup language, a download agent module for downloading data, a bookmark module, a web-kit module, and so forth.

The service module 1366 is a module including applications for providing various services. More specifically, the service module 1366 may include program modules such as a navigation program, a content reproduction program, a game program, an electronic book program, a calendar program, an alarm management program, other widgets, and so forth.

It should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of determining a relative orientation of a plurality of devices, the method comprising:
detecting a continuous touch gesture on at least one of the plurality of devices;
determining, based on at least one characteristic of the continuous touch gesture, the relative orientation of at least one of the plurality of devices; and
displaying, based on the determined relative orientation, an image on a display of at least one of the plurality of devices.

2. The method of claim 1, wherein the at least one characteristic of the continuous touch gesture comprises at least one of a position, a time, a velocity and a direction of the continuous touch gesture.

3. The method of claim 1, wherein at least one of the plurality of devices comprises a compass sensor,
wherein the display of the at least one of the plurality of devices comprises a touch screen display, and
wherein the continuous touch gesture is detected on the touch screen display of the at least one of the plurality of devices.

4. The method of claim 1, wherein the determining of the relative orientation of at least one of the plurality of devices comprises:
detecting a velocity and a time of the touch gesture at an exit point from one of the plurality of displays;
detecting a velocity and a time of the touch gesture at an entry point of the touch gesture at another one of the plurality of displays;
calculating a difference between the velocity and the time at the exit point and at the entry point; and
interpolating, based on the difference calculation, the shape of the touch gesture and the orientation of the displays.

5. The method of claim 1, further comprising:
interpolating, when a portion of the continuous touch gesture is absent, the absent portion of the continuous touch gesture.

6. The method of claim 1, wherein the plurality of devices together comprise a virtual screen and each of the plurality of devices display a respective portion of the virtual screen.

7. At least one non-transitory processor readable medium for storing a computer program of instructions configured to be readable by at least one processor for instructing the at least one processor to execute a computer process for performing the method as recited in claim 1.

8. A system of determining a relative orientation of a plurality of devices, the system comprising:
the plurality of devices;
a sensor configured to detect a continuous touch gesture on at least one of the plurality of devices;
a controller configured to determine, based on at least one characteristic of the continuous touch gesture, the relative orientation of at least one of the plurality of devices; and
a display on at least one of the plurality of devices configured to display an image based on the determined relative orientation.

9. The system of claim 8, wherein the at least one characteristic of the continuous touch gesture comprises at least one of a position, a time, a velocity and a direction of the continuous touch gesture.

10. The system of claim 8, wherein at least one of the plurality of devices comprises a compass sensor,
wherein the display of the at least one of the plurality of devices comprises a touch screen display, and
wherein the continuous touch gesture is detected on the touch screen display of the at least one of the plurality of devices.

11. The system of claim 8, further comprising:
a detecting unit configured to detect a velocity and a time of the touch gesture at an exit point from one of the plurality of displays and a velocity and a time of the touch gesture at an entry point of the touch gesture at another one of the plurality of displays,
wherein the controller is further configured to calculate a difference between the velocity and the time at the exit point and at the entry point, and to interpolate, based on the difference calculation, the shape of the touch gesture and the orientation of the displays.

12. The system of claim 8, wherein the controller is further configured to interpolate, when a portion of the continuous touch gesture is absent, the absent portion of the continuous touch gesture.

13. The system of claim 8, wherein the plurality of devices together comprise a virtual screen and each of the plurality of devices display a respective portion of the virtual screen.

14. An electronic device, the device comprising:
a sensor configured to detect a continuous touch gesture;
a controller configured to determine, based on at least one characteristic of the continuous touch gesture, the relative orientation of the electronic device with respect to at least one other electronic device; and
a display configured to display an image based on the determined relative orientation.

15. The electronic device of claim 14, wherein the at least one characteristic of the continuous touch gesture comprises at least one of a position, a time, a velocity and a direction of the continuous touch gesture.

16. The electronic device of claim 14, wherein the device comprises a compass sensor,
wherein the display comprises a touch screen display, and
wherein the continuous touch gesture is detected on the touch screen display.

17. The electronic device of claim 14, further comprising:
a detecting unit configured to detect a velocity and a time of the touch gesture at an exit point from one of the plurality of displays and a velocity and a time of the touch gesture at an entry point of the touch gesture at another one of the plurality of displays.

18. The electronic device of claim 17, wherein the controller is further configured to calculate a difference between the velocity and the time at the exit point and at the entry point, and to interpolate, based on the difference calculation, the shape of the touch gesture and the orientation of the displays.

19. The electronic device of claim 14, wherein the controller is further configured to interpolate, when a portion of the continuous touch gesture is absent, the absent portion of the continuous touch gesture.

20. The electronic device of claim 14, wherein the electronic device communicates with other electronic devices to comprise a virtual screen and displays thereon a respective portion of the virtual screen.
